(19) United States
(12) Patent Application Publication
(10) Pub. No.: US 2023/0281438 A1
(43) Pub. Date: Sep. 7, 2023

(54) Consistency-Regularization Based Approach for Mitigating Catastrophic Forgetting in Continual Learning

(71) Applicant: NavInfo Europe B.V., Eindhoven (NL)

(72) Inventors: Prashant Shivaram Bhat, Eindhoven (NL); Elahe Arani, Eindhoven (NL); Bahram Zonooz, Eindhoven (NL)

(21) Appl. No.: 17/686,276

(22) Filed: Mar. 3, 2022

(51) Int. Cl. G06N 3/08; G06N 3/10

(52) U.S. Cl. CPC G06N 3/08; G06N 3/10

(57) ABSTRACT

A deep learning framework in continual learning that enforces consistency in predictions across time separated views and enables learning rich discriminative features for mitigating catastrophic forgetting in low buffer regimes. A deep-learning based computer-implemented method for continual learning over non-stationary data streams involves a number of sequential tasks (T) in which for each task (t) the method includes the steps of training a classification head with an objective function based on experience replay; and casting consistency regularization as an auxiliary self-supervised pretext-task.

### BACKGROUND OF THE INVENTION

### Field of the Invention

Embodiments of the present invention relate to a computer-implemented method in deep neural networks for mitigating catastrophic forgetting in continual learning (CL) over non-stationary data.

### Background Art

Continual learning refers to a learning paradigm where computational systems learn with data becoming progressively available over time by accommodating new knowledge while retaining previously learned experiences [1]. Learning tasks sequentially through continual learning is one of the biggest challenges of modern-day machine learning. A significant hurdle in continual learning is the tendency of artificial neural networks to forget previously learned information upon acquiring new information, referred to as catastrophic forgetting [14]. This phenomenon typically leads to swift drop in performance or, in the worst case, leads to previously learned information being completely overwritten by the new one [15]. The problem of catastrophic forgetting manifests in many domains including continual learning, multitask learning, and supervised learning under domain shift.

An ideal continual learning system must be plastic enough to integrate novel information and stable enough to not interfere with the consolidated knowledge [15]. In deep neural networks however, sufficient plasticity to acquire new tasks results in large weight changes disrupting consolidated knowledge, known as catastrophic forgetting. Although keeping network’s weights stable mitigates forgetting, too much stability prevents the model from learning new tasks. Experience-Replay (ER) has been extensively used in the literature to address the problem of catastrophic forgetting. However, ER based methods show strong performance only in presence of large buffer size and fail to perform well under low-buffer regimes and longer task sequences.

Consistency regularization has been a widely used technique in semi-supervised learning on image data (e.g. [8, 9]). The core idea is simple: input image is perturbed in semantic-preserving ways and the classifier’s sensitivity to perturbations is penalized. Consistency regularizer forces the classifier to learn representations invariant to semantic-preserving perturbations. These perturbations can manifest in many ways: It can be augmentations such as random cropping, Gaussian noise, colorization or even adversarial attacks. The regularization term is either mean-squared error [10] between the model’s output of perturbed and non-perturbed images or KL-divergence [11] between the distribution over classes implied by the logits.

### BRIEF SUMMARY OF THE INVENTION

It is an object of the current invention to correct the shortcomings of the prior art and to provide a framework in continual learning that mitigates catastrophic forgetting in low buffer regimes. This and other objects which will become apparent from the following disclosure, are provided with a deep-learning based computer-implemented method for continual learning over non-stationary data streams, having the features of one or more of the appended claims.

Embodiments of the present invention are directed to a computer-implemented method comprising a number of sequential tasks (T) wherein for each task (t) the method comprises the steps of training a classification head with a cross-entropy objective function based on experience replay; and casting consistency regularization as an auxiliary self-supervised pretext-task. Such framework enforces consistency in predictions across time separated views and enables learning rich discriminative features thereby further mitigating catastrophic forgetting in low buffer regimes.

Advantageously, the step of training a classification head with a cross-entropy objective function based on experience replay comprises storing a subset of training data from previous tasks in a memory buffer (Dr) and replaying said training data alongside a task-specific data distribution (Dt).

More advantageously, the step of casting consistency regularization as an auxiliary self-supervised pretext-task comprises aligning past and current predictions of buffered samples.

Additionally, the step of casting consistency regularization as an auxiliary self-supervised pretext-task comprises maximizing mutual information between a number of views by approximating a conditional joint distribution over said number of views. Suitably, said views are separated through time. And, at least one prediction is an augmented view. The augmented view is a randomly cropped view, and/or a horizontally flipped view.

In an advantageously embodiment of the invention, the method comprises a backbone network (fθ) and a linear classifier (hθ) representing classes in a class-incremental-learning scenario.

### BRIEF DESCRIPTION OF THE SEVERAL VIEWS OF THE DRAWINGS

The invention will hereinafter be further elucidated with reference to the drawing of an exemplary embodiment of a computer-implemented method according to the invention that is not limiting as to the appended claims. In the drawings:

FIG. 1 shows a schematic diagram for the computer-implemented method according to an embodiment of the present invention; and

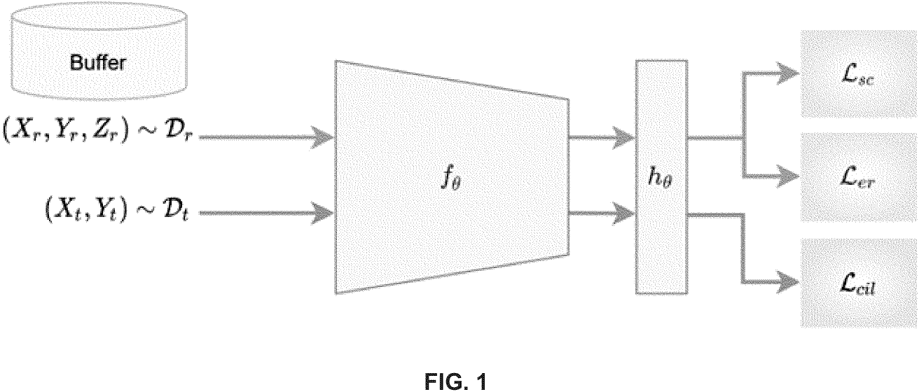

FIG. 2 shows the algorithm for the proposed framework according to an embodiment of the present invention.

### DETAILED DESCRIPTION OF THE INVENTION

Continual learning normally consists of T sequential tasks indexed by t ∈ (1, 2, ..., T). During each task, the input samples and the corresponding labels (xi, yᵢ) are drawn from the task-specific data distribution Dt. For each task, labels belong to a task-specific class set Yt ∈ Ct.

$${L}_{c i l} ≜ {\sum }_{t = 1}^{T} {E}_{\left({X}_{t} , {Y}_{t}\right) \sim {D}_{t}} \left[{l}_{c e} \left({Y}_{t} , {Φ}_{θ} \left({X}_{t}\right)\right)\right] \qquad \text{(Equation 1)}$$

For the sake of simplicity, Class Incremental Learning (Class-IL) objective in above equation is considered in further discussions. The proposed method can be easily extended to other continual learning scenarios such as domain-incremental learning, task-incremental learning and general-incremental learning. The continual learning model Φ_{θ} = {f_{θ}, h_{θ}} comprises a backbone network fe (such as ResNet-18 [23]) and a linear classifier he representing all classes in a Class-IL scenario. The model Φ_{θ} is sequentially optimized on one task at a time up to the current one t ∈ (1, ..., Tc) with the cross-entropy objective function in Equation 1.

Continual learning is especially challenging since the data from the previous tasks are unavailable i.e. at any point during training, the model Φ_{θ} has access to the current data distribution Dt alone. As the cross-entropy objective function in Equation 1 is solely optimized for the current task, plasticity overtakes stability resulting in overfitting on the current task and catastrophic forgetting of older tasks. Experience-Replay (ER) based methods sought to address this problem by storing a subset of training data from previous tasks and replaying them alongside Dt. For ER-based methods, the additional objective function can be written as:

$${L}_{c r} ≜ {E}_{\left({X}_{r} , {Y}_{r}\right) \sim {D}_{r}} \left[{l}_{c e} \left({Φ}_{θ} \left({X}_{r}\right) , {Y}_{r}\right)\right] \qquad \text{(Equation 2)}$$

where Dᵣ represents the distribution of samples stored in the buffer. ER-based methods partially improve the stability-plasticity dilemma through twin objectives: supervisory signal from Dt improves plasticity while that from Dr ameliorates the stability, thus partially addressing catastrophic forgetting. In practice, only a limited number of samples are stored in the buffer owing to memory constraints (|Dₜ| » |Dᵣ|). Catastrophic forgetting largely remains unaddressed in low-buffer regimes.

Consistency regularization plays a pivotal role in approximating the past behavior by enforcing consistency across current and past exemplar outputs separated through time. Since Lₑᵣ is already enforcing consistency among ground truths, we resort to output logits. Enforcing consistency in CL is akin to solving a pretext-task of bringing current and past exemplar outputs closer in the representational space by learning corresponding shared context (i.e. buffered image). Therefore, the method according to the invention comprises casting consistency regularization as an auxiliary self-supervised pretext task. Unsupervised task-agnostic representation learning in a shared context can be achieved through maximizing mutual information l(Z_{θ};Zᵣ). Formally, the conditional joint distribution over multi-views can be approximated through P_{rθ} = p(Z_{θ};Zᵣ|X) = σ(Φ_{θ}(X))▪ σ(Φᵣ(X)). The marginals P_{θ} = p(Z_{θ}) and Pᵣ = p(Zᵣ) can be obtained by summing over rows and columns of P_{rθ} matrix. Mutual information maximization can thus be achieved as follows:

$${L}_{s c} ≜ - {\sum }_{{Z}_{θ}} {\sum }_{{Z}_{r}} {P}_{r θ} \text{ln} \frac{{P}_{r θ}}{{P}_{θ} {P}_{r}} \qquad \text{(Equation 3)}$$

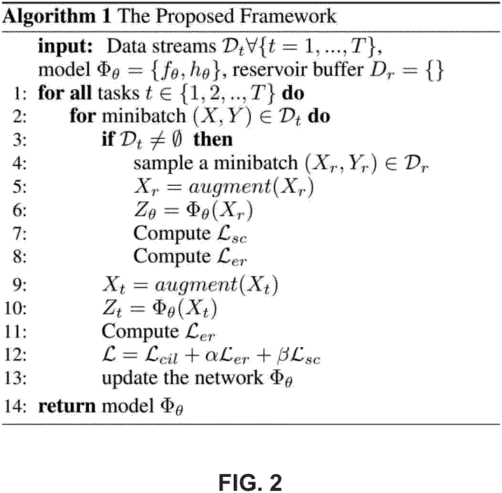

The final CL learning objective with consistency regularization can thus be defined as:

$$L = {L}_{c i l} + α {L}_{e r} + β {L}_{s c} \qquad \text{(Equation 4)}$$

where α and β are hyperparameters for adjusting the magnitudes of the loss functions. The algorithm for the proposed framework is defined as shown in FIG. 2.

### Experimental Results

An extensive analysis is hereinafter provided in order to shed light on the superiority of the method according to the invention in terms of robustness under natural image corruptions and noisy labels, model calibration and bias towards recent tasks.

Following [1], the following CL scenarios are evaluated:
Class Incremental Learning (Class-IL): The CL model encounters a new set of classes in each task and must learn to distinguish all classes encountered thus far after each task. In practice, we split CIFAR-10 [20] into partitions of 2 classes per task, respectively. Task Incremental Learning (Task-IL), although similar to Class-IL, accesses task identities to select relevant classifier for each data sample. The results of our evaluation on S-CIFAR10 are as follows:
Domain Incremental Learning (Domain-IL): The number of classes remain the same across subsequent tasks. However, a task-dependent transformation is applied changing the input distribution for each task. Specifically, R-MNIST [21] rotates the input images by a random angle in the interval [0; TT]. R-MNIST requires the model to classify all 10 MNIST [22] digits for 20 subsequent tasks. The results of our evaluation of R-MNIST are as follows:
General Incremental Learning (General-IL): In this setting, MNIST-360 [1] models a stream of MNIST data with batches of two consecutive digits at a time. Each sample is rotated by an increasing angle and the sequence is repeated six times. General-IL exposes the CL model to both sharp class distribution shift and smooth rotational distribution shift. The results of our evaluation of MNIST-360 are as follows:

Embodiments of the present invention can include every combination of features that are disclosed herein independently from each other.

Although the invention has been discussed in the foregoing with reference to an exemplary embodiment of the method of the invention, the invention is not restricted to this particular embodiment which can be varied in many ways without departing from the invention. The discussed exemplary embodiment shall therefore not be used to construe the append-ed claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

Optionally, embodiments of the present invention can include a general or specific purpose computer or distributed system programmed with computer software implementing steps described above, which computer software may be in any appropriate computer language, including but not limited to C++, FORTRAN, ALGOL, BASIC, Java, Python, Linux, assembly language, microcode, distributed programming languages, etc. The apparatus may also include a plurality of such computers / distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

### References

1. Pietro Buzzega, Matteo Boschini, Angelo Porrello, Davide Abati, and Simone Calderara. Dark experience for gen-eral continual learning: a strong, simple baseline. In34th Conference on Neural Information Processing Systems(NeurIPS 2020), 2020

2. Demis Hassabis, Dharshan Kumaran, Christopher Summerfield, and Matthew Botvinick. Neuroscience-inspired arti-ficial intelligence. Neuron, 95(2):245-258, 2017. ISSN 0896-6273.

3. Martial Mermillod, Aur’elia Bugaiska, and Patrick Bonin. The stability-plasticity dilemma: Investigating the contin-uum from catastrophic forgetting to age-limited learning effects. Frontiers in psychology, 4:504, 2013.

4. Roger Ratcliff. Connectionist models of recognition memory: constraints imposed by learning and forgetting func-tions.Psychological review, 97(2):285, 1990.

5. David Lopez-Paz and Marc’Aurelio Ranzato. Gradient episodic memory for continual learning.Advances in neuralinformation processing systems, 30:6467-6476, 2017.

6. Arslan Chaudhry, Marc’Aurelio Ranzato, Marcus Rohrbach, and Mohamed Elhoseiny. Efficient lifelong learning witha-gem. InICLR, 2019

7. Sylvestre-Alvise Rebuffi, Alexander Kolesnikov, Georg Sperl, and Christoph H. Lampert. icarl: Incremental classifierand representation learning. InProceedings of the IEEE Conference on Computer Vision and Pattern Recognition(CVPR), July 2017

8. Philip Bachman, Ouais Alsharif, and Doina Precup. Learning with pseudo-ensembles.Advances in neural informationprocessing systems, 27, 2014.

9. Xiaohua Zhai, Avital Oliver, Alexander Kolesnikov, and Lucas Beyer. S4l: Self-supervised semi-supervised learning.InProceedings of the IEEE/CVF International Conference on Computer Vision, pp. 1476-1485, 2019.

10. Mehdi Sajjadi, Mehran Javanmardi, and Tolga Tasdizen. Regularization with stochastic transformations and perturba-tions for deep semi-supervised learning.Advances in neural information processing systems, 29, 2016

11. Takeru Miyato, Shin-ichi Maeda, Masanori Koyama, and Shin Ishii. Virtual adversarial training: a regularization method for supervised and semi-supervised learning. IEEE transactions on pattern analysis and machine intelli-gence, 41(8):1979-1993, 2018

12. Ari Benjamin, David Rolnick, and Konrad Kording. Measuring and regularizing networks in function space. InInternational Conference on Learning Representations, 2018

13. Elahe Arani, Fahad Sarfraz, and Bahram Zonooz. Learning fast, learning slow: A general continual learning method based on complementary learning system. arXiv preprint arXiv:2201.12604 (2022).

14. lan J Goodfellow, Mehdi Mirza, Da Xiao, Aaron Courville, and Yoshua Bengio. An empirical investigation of catastrophic forgetting in gradient-based neural networks. arXiv preprint arXiv:1312.6211, 2013.

15. German I Parisi, Ronald Kemker, Jose L Part, Christopher Kanan, and Stefan Wermter. Continual lifelong learning with neural networks: A review. Neural Networks, 113:54-71, 2019.

16. Friedemann Zenke, Ben Poole, and Surya Ganguli. Continual learning through synaptic intelligence. In International Conference on Machine Learning, pp. 3987-3995. PMLR, 2017

17. Jonathan Schwarz, Wojciech Czarnecki, Jelena Luketina, Agnieszka Grabska-Barwinska, Yee Whye Teh, Razvan Pascanu, and Raia Hadsell. Progress & compress: A scalable framework for continual learning. In International Conference on Machine Learning, pp. 4528-4537. PMLR, 2018.

18. Andrei A Rusu, Neil C Rabinowitz, Guillaume Desjardins, Hubert Soyer, James Kirkpatrick, Koray Kavukcuoglu, Razvan Pascanu, and Raia Hadsell. Progressive neural networks. arXiv preprint arXiv:1606.04671, 2016

19. Sebastian Farquhar and Yarin Gal. Towards robust evaluations of continual learning. arXiv preprint arXiv:1805.09733, 2018.

20. A. Krizhevsky. Learning multiple layers of features from tiny images. 2009

21. David Lopez-Paz and Marc’Aurelio Ranzato. Gradient episodic memory for continual learning. Advances in neuralinformation processing systems, 30:6467-6476, 2017

22. Y. Lecun, L. Bottou, Y. Bengio, and P. Haffner. Gradient-based learning applied to document recognition.Proceedingsof the IEEE, 86(11):2278-2324, 1998. doi: 10.1109/5.726791.

23. He, Kaiming, Xiangyu Zhang, Shaoqing Ren, and Jian Sun. “Deep residual learning for image recognition.” In Proceedings of the IEEE conference on computer vision and pattern recognition, pp. 770-778. 2016.

What is claimed is:

1. A deep-learning based computer-implemented method for continual learning over non-stationary data streams comprising a number of sequential tasks (T) wherein for each task (t) the method comprises the steps of:
training a classification head with a cross-entropy objective function based on experience replay; and
casting consistency regularization as an auxiliary self-supervised pretext-task.

2. The computer-implemented method according to claim 1 wherein the step of training a classification head with a cross-entropy objective function based on experience replay comprises storing a subset of training data from previous tasks in a memory buffer (Dᵣ) and replaying said training data alongside a task-specific data distribution (Dt).

3. The computer-implemented method according to claim 1, wherein the step of casting consistency regularization as an auxiliary self-supervised pretext-task comprises aligning past and current predictions of buffered samples.

4. The computer-implemented method according to claim 1, wherein the step of casting consistency regularization as an auxiliary self-supervised pretext-task comprises maximizing mutual information between past and current predictions of buffered samples by approximating a conditional joint distribution over the predictions.

5. The computer-implemented method according to claim 4, wherein said predictions are separated through time.

6. The computer-implemented method according to claim 4, wherein at least one prediction is an augmented view.

7. The computer-implemented method according to claim 6, wherein the augmented view is a randomly cropped view, and/or a horizontally flipped view.

8. The computer-implemented method according to claim 1, wherein the method further comprises a backbone network (f_{θ}) and a linear classifier (he) representing classes in a class-incremental-learning scenario.

9. A computer-readable medium provided with a computer program which, when loaded and executed by a computer, causes the computer to carry out the steps of the computer-implemented method according to claim 1.

10. A data processing system comprising a computer loaded with a computer program to cause the computer to carry out the steps of the computer-implemented method according to claim 1.
